(19) United States
(12) Patent Application Publication
(10) Pub. No.: US 2010/0017259 A1
(43) Pub. Date: Jan. 21, 2010

(54) METHOD AND SYSTEM OF AUTOMATICALLY SETTING AND CHANGING PRICE FOR ONLINE CONTENT SELLING

(75) Inventor: Xiaofen Luo, Novato, CA (US)

Correspondence Address: FENWICK & WEST LLP, SILICON VALLEY CENTER, 801 CALIFORNIA STREET, MOUNTAIN VIEW, CA, 94041, US

(73) Assignee: Publiso, Inc., Novato, CA (US)

(21) Appl. No.: 12/173,538

(22) Filed: Jul. 15, 2008

(51) Int. Cl. G06Q 10/00

(52) U.S. Cl. 705/10; 705/400

(57) ABSTRACT

A system, method, and product that enable users to conveniently receive financial benefits from publishing content online are described. A price for a piece of content is dynamically set in the following manner. The piece of content is initially published for free, and categorized for a related category. Related user activities are tracked and used by a business rule to determine a marketability value for the piece of content. If the marketability value exceeds a threshold, a price is determined by applying a pricing algorithm to the marketability value. Subsequent accesses to the piece of content are subject to the price. User activities related to the piece of content are continuously tracked and used to adjust the price.

### BACKGROUND

1. Field of Disclosure

The disclosure generally relates to the field of electronic commerce (e-commerce), in particular to price management for online content commerce.

2. Description of the Related Art

The number of Internet users has been continuously growing at high speed for more than a decade. It also becomes common for Internet users to publish content online, such as posting diaries (e.g., keeping personal BLOGs), publishing photos (e.g., posting pictures onto Flickr™), and sharing multimedia works (e.g., uploading video clips onto YouTube™). Users sometimes spend substantial time and energy in generating these content, and some of the content have been proven very successful. Like creators of other assets, the creators of these user-generated content deserve to be recognized and compensated financially for their creation. However, currently there is no adequate solution on the market for ordinary Internet users to publish user-generated content and financially benefit from such content.

One common conventional approach for Internet users to publish content online is through content hosting providers such as MySpace™ and GeoCities™. These content hosting providers provide services to users to publish their content online. These services may be free and supported by paid advertisements. However, content creators and publishers do not receive any financial reward from their works.

One common conventional approach to publish content online for financial benefit is through selling content at a fixed price. Examples include downloadable e-books sold through retailers such as Amazon™ and articles accessible at business publishers such as Wall Street Journal™. This approach may work for writers with established reputation, but would not work for ordinary users because it is unlikely that potential audience is willing to pay for their works.

In addition, it is difficult to set a meaningful price for a piece of content even for expert in the related field, let alone an ordinary Internet user. In order to come up with a financially sound price for a piece of content, it is necessary for one to know the reader market (e.g., whether the subject matter is currently popular), to assess the feasibility of charging readers a fee to view the content, and to determine a price level that is acceptable for readers. Apparently these information and judgments are too much challenge for a majority of the regular unsophisticated Internet users. As a result, users probably would either over-price or under-price their works, or more likely give up all together and give out their works for free, and suffer unnecessary financial losses.

Further, fixed price for online content is by nature insufficient because reader market changes constantly. For example, love stories may be popular for a while before being exceeded by science fictions. A certain type of content may experience a change in market demand, too. For example, as the number of high speed Internet service subscribers increases, video content gains popularity. Fixed content price cannot reflect these reader market trend changes. In addition, creators of the user-generated works may not be aware of these trend changes and therefore cannot adequately adjust prices for their works in a timely manner.

Hence, there is lacking, inter alia, a system and method for users to conveniently receive financial benefits from published content by dynamically pricing the published content based on relevant reader market movements.

### SUMMARY

Embodiments of the present invention/disclosure provide a method (and corresponding system and computer program product) for users to conveniently receive financial benefits from publishing content online. In one embodiment of the present invention, a price for a piece of content is dynamically set in the following manner. The piece of content is initially published for free, and categorized for a related category. Related user activities are tracked and used by a business rule to determine a marketability value for the piece of content. If the marketability value exceeds a threshold, a price (base price) is determined by applying a pricing algorithm to the marketability value. Subsequent accesses to the piece of content are subject to the price. User activities related to the piece of content are continuously tracked and used to adjust the price (base price and real time price).

Advantages of the disclosed method include a convenient way for ordinary Internet users to publish content online and receive financial benefit from the published content. A user does not need to understand the relevant reader market or marketability of the subject matter, and only needs to turn on the automated pricing service. The service will determine content price that is market-driven, dynamic, and real-time.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF DRAWINGS

The disclosed embodiments have other advantages and features which will be more readily apparent from the detailed description, the appended claims, and the accompanying drawings (figures). A brief description of the drawings is as follows:

Figure (FIG.) 1 is a diagram illustrating a computing environment for providing an online content e-commerce platform in accordance with one embodiment of the invention.

FIG. 2 is a diagram illustrating a structure of a computer in accordance with one embodiment of the invention.

FIG. 3 is a diagram showing modules within the content commerce system shown in FIG. 1 in accordance with one embodiment of the invention.

FIGS. 4A and 4B are flow diagrams illustrating operations of a content pricing subsystem shown in FIG. 3 in accordance with one embodiment of the invention.

FIGS. 5A and 5B are time sequence diagrams illustrating an operation of a content pricing subsystem 340 shown in FIG. 3 in accordance with one embodiment of the invention.

FIGS. 6A through 6H include a series of screenshots illustrating an example user experience corresponding to the operation of a content pricing subsystem 340 illustrated in FIGS. 5A and 5B in accordance with one embodiment of the invention.

### DETAILED DESCRIPTION

The present invention provides a method and system for ordinary Internet users to conveniently publish content online and receive financial benefits from the published content by dynamically determining content price based on relevant reader market trend movements.

Users creating content (creators, authors), publishing content (publishers), and selling content (sellers) are collectively called publishers. Users accessing content (readers, visitors) and purchasing content (purchasers, buyers) are collectively called visitors. Publishers and visitors are also collectively addressed as users.

The content being published utilizing the present invention can be electronic content in any format (textual, audio, video, picture, game, Flash, to name only a few), generated by users or otherwise.

### Overview

FIG. 1 is a diagram illustrating a computing environment 100 for providing an online content e-commerce platform to average Internet users in accordance with one embodiment of the invention. The computing environment 100 includes a content commerce system 110 and multiple client systems 120 communicatively connected through a network 130. As illustrated, the computing environment employs client-server architecture, the content commerce system 110 functions as the server system and the client systems 120 function as the client systems. It is noted that the present invention is not restricted to this architecture, and can be implemented in other architectures such as Peer-to-Peer architecture.

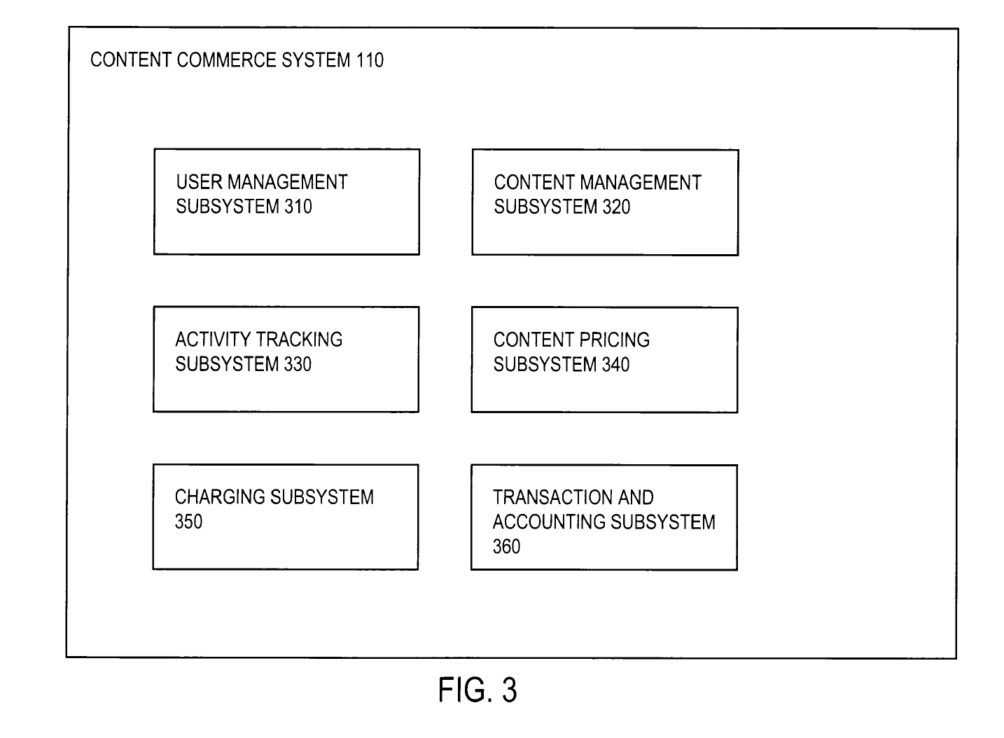

The content commerce system 110 is a hardware and/or software device that enables users to publish and manage content online, and to engage in related financial transactions (e.g., set content price, purchase and sell content) by interacting with their client systems 120. A detailed example module architecture of the content commerce system 110 is described in detail below with respect to FIG. 3. In one implementation, the content commerce system 110 includes three groups of clustered servers: web application severs 112, database servers 114, and dedicated file servers 116. The number of the servers 112, 114, 116 can be adjusted based on a preferred scale of the content commerce system 110.

The web application servers 112 are responsible for receiving, processing, and returning user requests as well as triggering backend functions. In one embodiment, the web application server 112 provides applications and functions such as the following: content display, editorial management application, user activity tracking (e.g., page view, search, comment, forum, purchase), publisher price trigger, content price display, visitor payment trigger, user account management application, publisher content self-organization, content/publisher bookmark, voting/rating record-keeping, and in-site messaging.

The database servers 114 function as data depository and are responsible for backend functions processing. In one embodiment, the database server 114 includes multiple databases such as the following: content databases, user activity tracking database, publisher pricing database, publisher charging database, visitor payment transaction database, and user account database. The file servers 116 store user uploaded files such as photos and video clips.

A client system 120 is a hardware and/or software device for users to interact with the content commerce system 110 through the network 130. Examples of a client system 120 include a personal computer (laptop or desktop), a mobile phone, a personal digital assistant (PDA), and other mobile computing devices. The client system 120 can have one or more operating systems such as Microsoft Windows, Mac OS, LINUX, and/or a variant of UNIX. In one embodiment, a client device 120 includes a browser application (e.g., Palm Blazer™, Opera mobile browser, Microsoft Internet Explorer™, Mozilla Firefox™, or Apple Safari™) for users to access and interact with web pages retrieved from the web application servers 112.

A user can be a publisher publishing content on the content platform or a visitor accessing the published content. Depending on whether a user is a publisher or a visitor, the user conducts different user activities using his client system 120. It is noted that a user can be both a publisher and a visitor. A visitor may conduct user activities such as: browsing content (also referred to as content page view), bookmarking or tracking content or publisher, making recommendations to acquaintances, voting or rating content or publisher, purchasing content, commenting or providing feedbacks to content or publishers, conducting content searches (within or outside the content platform), participating in discussions (within or outside the content platform). A publisher may conduct user activities such as: authoring and publishing content, managing and editing content, and selecting pricing models.

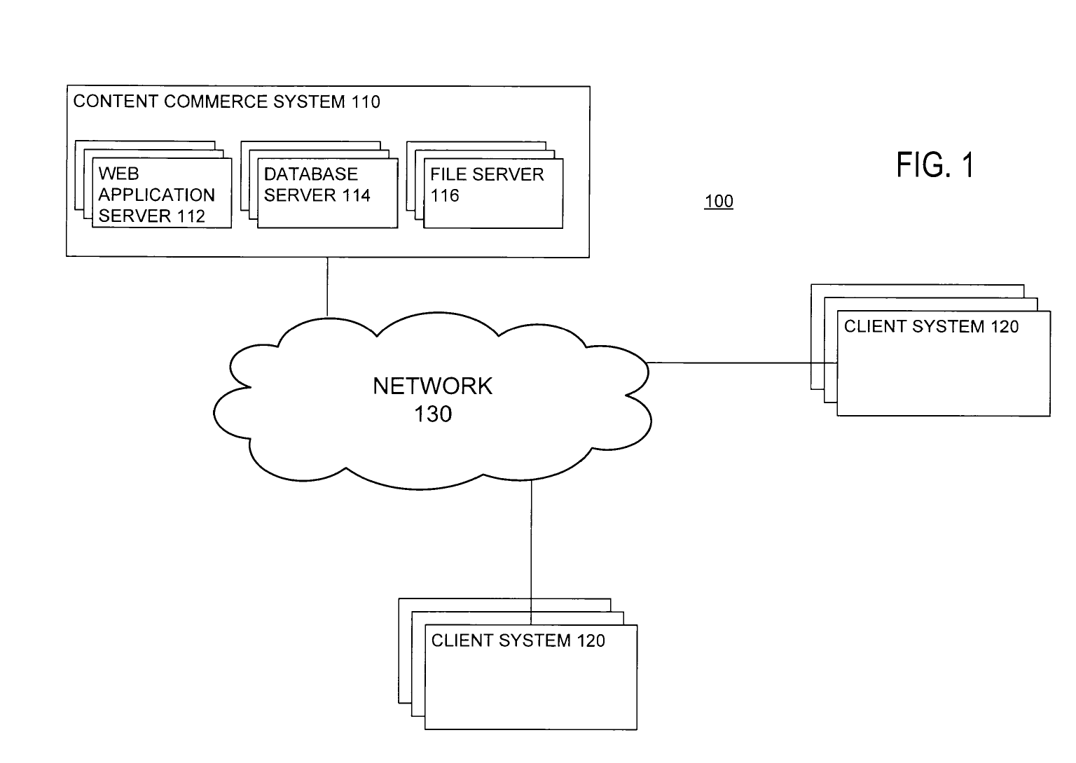

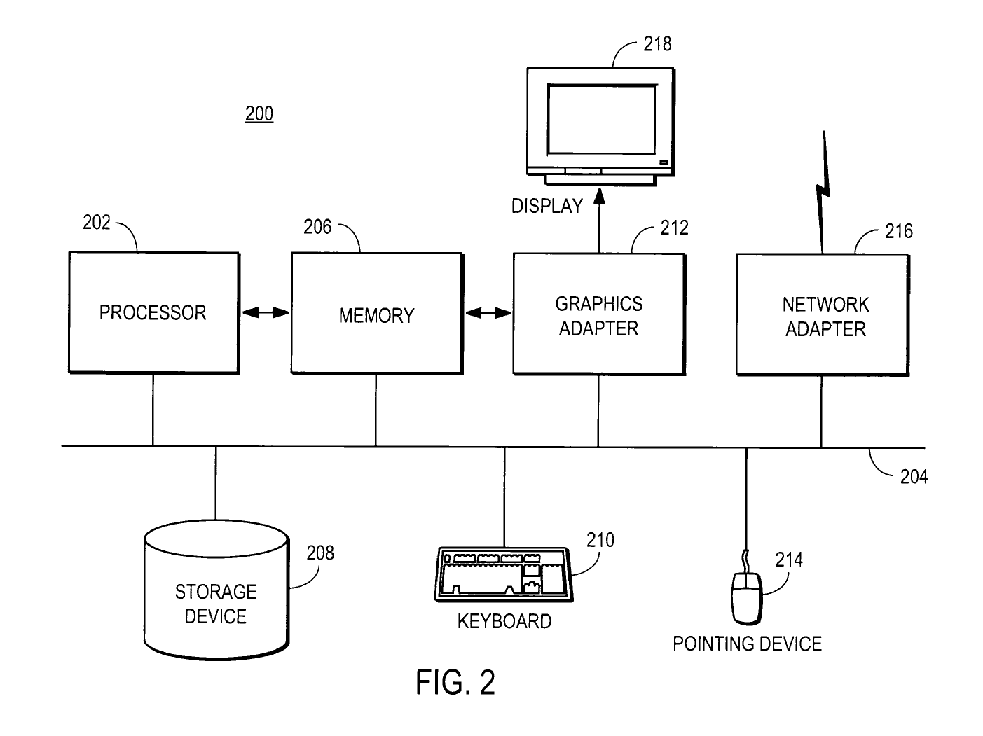

The content commerce system 110 and the client system 120 may be stored and operated on a computer 200 as illustrated in FIG. 2 in accordance with one embodiment of the invention. Referring to FIG. 2, the computer 200 includes at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

Referring back to FIG. 1, the network 130 is configured to connect the content commerce system 110 and the client systems 120. The network 130 may be a wired or wireless network. Examples of the network 130 include the Internet, an intranet, a WiFi network, a WiMAX network, a mobile telephone network, or a combination thereof.

In one embodiment, the content commerce system 110 hosts a website and provides the online content e-commerce platform through the website. Users can publish, access, and trade content by visiting the website using their client systems 120 through the network 130. Users can also manage their account by interacting with the website. The content commerce system 110 receives various user requests (e.g., requests to access or publish content) through the website, processes the requests, and generates request results. In one embodiment, the content commerce system 110 represents the request results using markup languages such as HyperText Markup Language (HTML) and transmits to the client system 120 for display as web pages through a browser.

### System Architecture for Content Commerce System

FIG. 3 is a high-level block diagram illustrating modules within the content commerce system 110 in FIG. 1 in accordance with one embodiment of the invention. Those of skill in the art will recognize that other embodiments can have different and/or additional modules than those shown in FIG. 3. Likewise, the functionalities can be distributed among the modules in a manner different than described herein. Further, some of the functions can be provided by entities other than the content commerce system 110.

As illustrated in FIG. 3, the content commerce system 110 includes a user management subsystem 310, a content management subsystem 320, an activity tracking subsystem 330, a content pricing subsystem 340, a charging subsystem 350, and a transaction and accounting subsystem 360. In one embodiment, the six subsystems 310-360 operate on the clustered web application servers 112, the clustered database servers 114, and the clustered file servers 116 of the content commerce system 110. It is noted that in alternate embodiments the content commerce system 110 can utilize alternate architectures such as the so-called cloud computing system environment.

The user management subsystem 310 is designed to manage users of the content platform. In one embodiment, in order for a user to publish and/or access content on the content platform, the user is required to register for an account with the platform. The user management subsystem 310 provides a sign-up mechanism for a user to create account, collects personal information (e.g., name and personal email address) from the user, and assigns a unique User ID (also referred to as Visitor ID) to the user. The User ID is used in the content commerce system 110 to uniquely identify the user. The user management subsystem 310 may also provide additional information about users. For example, the user management subsystem 310 may assign a Group ID to a group of users to signify their affiliation (e.g., the group members all participate in providing certain content).

The content management subsystem (also referred to as editorial management application) 320 is designed to facilitate users publishing and accessing content. The content management subsystem 320 enables users to publish content on the content platform. For example, the content management subsystem 320 may provide functionalities for users to create content (e.g., through online content editor such as a WYGIWYS (What You Get Is What You See) editor) and/or edit content. As another example, the content management subsystem 320 may enable publishers to transfer existing content (e.g., upload content, copy/paste content from external sources such as existing web pages) to the content platform. Users can create or provide content individually or collectively (e.g., multiple users can collectively create a wiki web page). Users can also manage their content through the content management subsystem 320. For example, a publisher can organize his contents by grouping certain content pieces together (e.g. into a series), ungrouping or reordering a series, or adding/removing content piece(s) into/from a series. Users can also relate content (individual pieces or series) by identifying their relationship (e.g., similar or opposite). In addition, the content management subsystem 320 enables users to access content published on the platform and/or content available elsewhere. For example, the content management subsystem 320 may enable users to search for content (e.g., by keywords, content type, subject category, or other criteria), organize content, or recommend content based on users' interest and/or algorithms such as collaborative filtering algorithms. The content management subsystem 320 is also configured to properly represent content to users based on the content type (e.g., text, image, audio, video) and/or a configuration of the client system 120 (e.g., screen size, resolution, audio setting).

The content management subsystem 320 provides a mechanism to uniquely identify a piece of content on the content platform and its publisher. When a user uploads a piece of content onto the content platform, the content management subsystem 320 assigns a unique Content ID to the uploaded content and identifies the user as the publisher by associating the content with the user's User ID. The content management subsystem 320 may utilize additional or different identification mechanisms to manage content when necessary. For example, if multiple pieces of content are related (e.g., a series of content such as BLOG entries), the content management subsystem 320 assigns a Series ID to them to signify their relationship. As another example, if a piece of content is created or published by a group of users (e.g., a wiki web page edited by multiple users), the content management subsystem 320 assigns a Group ID in place of the User ID to identify the group. Several pieces of content may also share a Thread ID (e.g., a thread of web posts in an Internet bulletin board) or an Association ID. In any form, the content management subsystem 320 uses Content ID (and/or Series ID, Thread ID, Association ID) to identify a piece (or a set) of content and uses the associated User ID (or Group ID) to identify a publisher (or a group of publishers) of the content.

The content management subsystem 320 also categorizes and/or subcategorizes all the content using pre-defined themes and/or topics. The content management subsystem 320 may analyze a piece of content (e.g., by searching keywords or detecting formats) to determine its category (and/or subcategory). Alternatively or additionally, the content management subsystem 320 may require users (e.g., the publisher) to categorize content. A piece of content may have zero or more than one categories (or subcategories). For example, a piece of content can be categorized as both fiction and short story. Content under different topics (or category or subcategory) have different expectations for their readership (e.g., content categorized under English are likely to have more readers than content categorized under a rarely used language). Therefore, topic (or category or subcategory) information for a piece of content can be used to determine content price. Users may also define content tags and use them to label content. The user-defined tags can also be used to categorize content and/or determine content price.

The activity tracking subsystem (also referred to as multi-factor/multi-angle visitor activity tracking system) 330 is designed to comprehensively track and store all user activities related to content on the content platform in real time (or close to real time). As described in detail below with regard to the content pricing subsystem 340, the tracked user activities are used to derive market data for determining market acceptance for content and content prices. Examples of the user activities include, but are not limited to, content viewing, content/publisher bookmarking, content/publisher rating, content/publisher sharing with other user/non-user, commenting, content purchasing, discussing content or publisher in in-site forums or out-site forums/BLOGs, searching content or publisher in-site or out-site. The activity tracking subsystem 330 may also track other perceivable user activities such as receiving an award in a writing competition or in a daily (or weekly, monthly, annually) auto-award program per user generated positive votes, and user voting. The activity tracking subsystem 330 may also be dynamically reconfigured to track additional user activities (e.g., audio or video signal generated on client systems 120, in-site, or out-site) as they become available. In one embodiment, the activity tracking subsystem 330 can be configured to operate independently from other components of the content commerce system 110. For example, disregarding whether the content pricing subsystem 340 generates pricing information for a piece of content, the activity tracking subsystem 330 always tracks user activities related to the piece of content in the backend. The activity tracking subsystem 330 is fully modulized and is expandable/scalable per business needs.

The activity tracking subsystem 330 can track user activities at different granularity levels. The activity tracking subsystem 330 may provide accurate tracking (referred to as “tight tracking” or level 1 tracking) for certain user activities, while conduct more rough tracking (“loose tracking” or level 2 tracking) for some other user activities, and general tracking (“trend tracking” or level 3 tracking) for the rest.

For example, the activity tracking subsystem 330 may exercise tight tracking on user activities where both User ID and Content ID are available, such as bookmarking, commenting, voting, purchasing, and recommending (e.g., “Tell A Friend”). These user activities require the user to sign in his account, and thus availing his User ID to the activity tracking subsystem 330. In one embodiment, the activity tracking subsystem 330 only counts a user activity once for each unique User ID and Content ID combination to avoid duplication.

For those user activities where Content ID is available but not User ID, the activity tracking subsystem 330 may exercise loose tracking. Examples of such loosely tracked user activities include page views, random in-site search or out-site searches, and forum discussions (in-site or out-site). The loosely tracked user activities, even though may not provide information about a specific user, may still provide market information for associated content, and be taken into account in determining their content prices.

For those user activities where neither Content ID nor User ID is available, the activity tracking subsystem 330 may exercise trend tracking. Examples of such user activities include general forum discussions and general web searches that do not involve content published in the content platform. These user activities provide high-level market trend information and can be used to determine marketability of content in certain category/topic.

For example, each time a visitor (User ID not available) views a piece of content, a page view user activity is tracked (level 2 tracking) and stored for the content. In case a user bookmarks or purchases the content, the activity is tracked (level 1 tracking) with the User ID and the Content ID. If an anonymous visitor left a post in an on-site bulletin expressing his passion in adventure stories, the post is tracked (level 3 tracking) for the category of adventure stories.

In one embodiment, the user activities tracked at different granularity levels are given different weights in a measurable manner, as detailed below with respect to activity factor constants. As noted above, the activity tracking subsystem 330 may also track user activities outside the platform. For example, the activity tracking subsystem 330 may install applets in the users' client systems 120 to track their activities outside the platform. In one implementation, the activity tracking subsystem 330 may selectively crawl/index a few major websites (e.g., NY Times) to retrieve user activities (e.g., book reviews). The content commerce system 110 can also provide web search capabilities for selected external websites to its users (referred to as target search engine).

The content pricing subsystem (also referred to as dynamic pricing system) 340 is designed to dynamically determine prices for content based on real time relevant user activities (also referred to as automated pricing service). In one embodiment, the content pricing subsystem 340 applies business rules (described in detail below) on the user activities tracked by the activity tracking subsystem 330 to derive market data, and applies pricing algorithms to determine content prices. A publisher can turn on the automated pricing service at any time, and the content pricing subsystem 340 will dynamically generate and adjust price for the underlying content. Alternatively, the publisher can choose to turn off the service and set a fixed do-it-yourself (DIY) pricing or no price (free content). The operation of the content pricing subsystem 340 is described in further detail below.

The content charging subsystem 350 is designed to store and output content prices. The price may be the automated dynamic pricing generated by the content pricing subsystem 340 for those with which the automated pricing service is turned on. If there is a price set up by a publisher, the charging subsystem 350 will receive, store, and display such a (fixed) price until the publisher changes the fixed price or switches to (turns on) the automated pricing service.

The transaction and accounting subsystem (also referred to as financial transaction subsystem) 360 is designed to track purchases/payments, sales/earnings, and/or accounting. If a visitor purchased a piece of content, the transaction and accounting subsystem 360 deducts an amount set forth by the content price from the visitor's account and deposits in the publisher's account. In one embodiment, the transaction and accounting subsystem 360 deducts a percentage (e.g., 20%) of the transaction price from the deposit as a service charge. The transaction and accounting subsystem 360 may also be configured to deposit or withdraw from user's external financial account (e.g., bank accounts, credit card accounts), payment accounts (e.g., PayPal™, Google™ Checkout), and/or utility billing accounts (e.g., mobile phone, electricity and gas). Users can access their accounts to review transactions e.g., purchases made, and sales made. In one embodiment, the transactions may involve credits, points, or other measurements in stead of or in addition to money. These additional measurements may or may not have monetary value.

### Operation of Content Pricing Subsystem

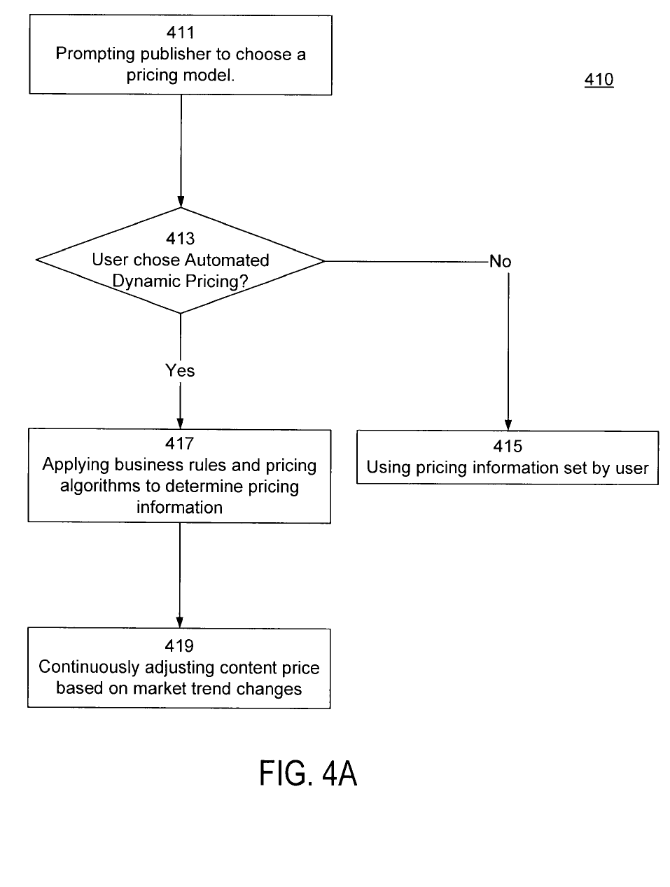

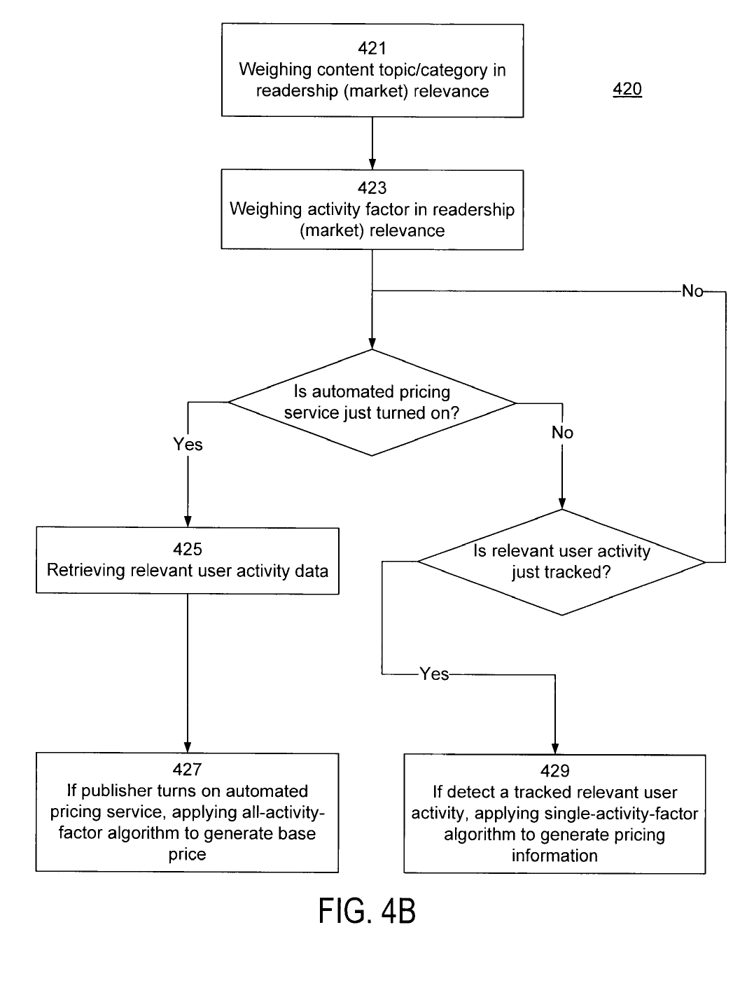

FIG. 4A is a flow diagram illustrating an example operation 510 of the content pricing subsystem 340 in accordance with one embodiment of the invention. As illustrated, the content pricing subsystem 340 is designed to automatically generate real time price for content based on market data derived from tracked user activities. In the following description, the automated pricing service provided by the content pricing subsystem 340 is also referred to as the PriceSensor service.

After a user publishes a piece (or series) of content (e.g., article, photo album, music, video, game, etc.) on the content platform, the content commerce system 110 starts tracking related user activities, and prompts 411 the user to choose one of three pricing model options: (1) publishing the content free of charge, (2) charging a fixed do-it-yourself (DIY) price, and (3) automated dynamic pricing. If the user chooses 413 the first or second option, then the content pricing subsystem 340 uses 415 the price set by the user (free or fixed price) as the content price. If the user chooses 413 the third option, then the content pricing subsystem 340 establishes an entry in a database (e.g., the publisher pricing database) for hosting relevant pricing information, applies 417 business rules to generate market data, and applies 417 pricing algorithms to the market data to determine pricing information for the content. In addition, the content pricing subsystem 340 will continuously adjust 419 the content price based on market trend changes in real time as long as the service is on.

Once a publisher turns off the service for certain content, the content commerce system 110 preserves the data (or records) related to the content, such that if and when the publisher turns on the service again, the content commerce system 110 will restore the data from wherever they were left. It is noted that in one embodiment, the content commerce system 110 tracks user activities related to a piece of content in the background regardless of the publisher's decision for the pricing model options.

### Business Rule and Market Data

The content pricing subsystem 340 generates market data for a piece of content by using applicable business rules. Business rules are logics that derive market data for a piece of content by quantifying its topic/category information and/or tracked relevant user activities. The content pricing subsystem 340 sets up customized business rules for each content topic/category and each activity factor. Other examples of business rules include business rules for the minimum visitor activity volumes (hereinafter called the MinAct threshold) that can trigger the content pricing subsystem 340 to determine a base price for relevant content. In one embodiment, business rules derive two types of market data, current market data (reflecting real-time reader market movements during a number of most recent time sessions, e.g., two most recent time sessions) and historical market data (reflecting historical reader market data accumulated since day one). The current market data is used to adjust real time price and the historical market data is used to adjust base price.

A business rule may assign weights (also referred to as market relevance value, activity factor constants) to user activity types (also referred to as activity factors). In one embodiment, the weight assigned to an activity factor is determined based on the visitor's interest level in the associated content reflected by the activity factor. If the interest level is high, then the assigned weight has a high value, and vice versa. For example, the activity factor of bookmarking a piece of content usually indicates a higher and more definite interest in the content than the user activity of viewing a page of the piece of content (also referred to as page view), and should be assigned a higher weight. The interest level reflected by an activity factor can be assigned by an administrator (e.g., based on common sense) or determined or adjusted based on statistical data (e.g., the activity's correlation with content purchase). Examples of user activity factors include award factor, bookmark factor, comment-mention factor, forum-mention factor, page-view factor, purchase factor, in-site search factor, tell-a-friend/mail-out factor, instant messaging/in-site-chat-mention factor, member-email/in-site-email factor, vote-score factor, relate factor, co-author/group-author factor, public edit/wiki edit factor, club fan factor, member bookmark/my-favorite factor, and out-site target search factor.

A business rule may also assign weights (also referred to as content topic constants, content category constants) to content topics and/or categories (e.g., poem, fiction, biography, science paper, pop music, historical photo album, sports report, adventure video, financial analysis, foreign language, and game clip). These weights can be assigned to different topics and/or categories (or themes, subcategories) based on common-sense definitions of their popularities among users. For example, images of celebrities are generally more popular than scientific white papers. Therefore, a scientific white paper with one thousand page views is determined by the content pricing subsystem 340 as more popular than a picture of a celebrity with the same number of page views. Thus, the content pricing subsystem 340 would assign a higher weight per page view to the scientific white paper than the celebrity picture based on the same number of page views.

It is noted that weights (activity factor constants or content category constants) can be adjusted as time passes. For example, as the popularity of bookmark activity factor changes, its associated constant can also be adjusted to reflect such change. The weights can also differ based on factors such as the underlying user's demographic classifications. For example, instant messaging factor may carry more weight to teenagers than retirees, while historical fiction category may be more interesting (and thus has a higher weight value) to retirees than teenagers. The weights can be assigned and adjusted by experts such as analysts, economists, media experts, and editors or automatically calculated based on statistical data.

The content pricing subsystem 340 can use the business rules to quantify market data related to a piece of content. The quantified market data are called price-weighing values, and can be used to determine marketability of the underlying content and associated content prices.

For example, an adventure story and a philosophic paper both have 1000 page views. Assume the content topic constant for adventure stories is 0.5, and the content topic constant for philosophic papers is 0.9, suggesting that adventure stories generally are more popular than philosophic papers. Assume the activity factor constant for the page view activity factor is 0.2 per page viewed. It follows that the price-weighing value for the adventure story is 0.5×(1000×0.2)=100, and the price-weighing value for the philosophic paper is 0.9×(1000×0.2)=180. Thus, with the mathematical result (data and calculation) and economic meaning (reality and common-sense) both considered, the content pricing subsystem 340 senses the philosophic paper is more popular among philosophic readers than the adventure story among more average readers. Accordingly, the content pricing subsystem 340 would give a higher dollar amount in pricing the philosophic paper attracting a narrower but a more willing-to-purchase philosophic reader market while a lower price tag, if any, for the adventure story in a much broader reader market.

Similarly, in another comparison between a total 1000-page view of the adventure story and a total 1000-bookmark of the philosophic paper, assume the activity factor constant for the bookmark activity factor is 0.7, the pricing weighing value for the adventure story would be 0.5×(1000×0.7)=350, while the pricing weighing value for the philosophic paper remains 180. This indicates more serious interest in the adventure story from readers and thus the adventure story would probably have a better sell.

### Pricing Algorithm and Price Structure

The content pricing subsystem 340 determines content price by applying pricing algorithms to market data. The price structure in the content pricing subsystem 340 can include four types of prices, each serving a different purpose: base price, real-time price, open price, and close price. There are also two pricing algorithms, each applicable in a different scenario: all-activity-factor algorithm and single-activity-factor algorithm. Each price type is described in detail below followed by detailed descriptions of the algorithms.

The base price is designed to serve as both a price starting point upon the fulfillment of an initial marketability requirement and an on-going bottom price reflecting accumulated value over time. In one embodiment, when a piece of content is first published on the content platform, the content pricing subsystem 340 avails it to all users free of charge. By availing the content for free, the content pricing subsystem 340 encourages interested users to access it, and thus promotes user activities that can be tracked and used to determine the content's marketability. When relevant user activities become available, the content pricing subsystem 340 applies business rules to determine whether the underlying content is marketable enough (e.g., by comparing to a marketability threshold value). In one embodiment, the business rules include minimum visitor activity volumes (the MinAct threshold) that can trigger the base price. In one embodiment, the base price is a predetermined amount (e.g., $0.10). Since the content pricing subsystem 340 has access to multiple tracked activity factors (e.g., page viewed, bookmarked, purchased), there can be multiple MinActs for measuring. For example, a business rule may require content in the category of love story to accrue minimum 100,000 page views (MinAct threshold for page view factor) before the content pricing subsystem 340 can set up a base price with a confidence in the likelihood of market acceptance. Another business rule may measure the marketability of content in the love story category by determining whether the underlying content has accrued 1,500 bookmarks (MinAct threshold for bookmark factor). It is noted that a business rule may consider multiple activity factors at the same time in determining whether to set up a base price. When one or more activity factors meet their MinAct thresholds, the content pricing subsystem 340 sets the base price for the underlying content.

The base price can also serve as a real-time bottom price when the marketability of the underlying content drops (e.g., reader market crashes). Once the base price is set, its value will increase gradually over time. The gradual value accumulation serves the purpose of a historical recognition of the content on the market and/or offsetting inflation. In other words, even though a downward market will cause the content pricing subsystem 340 to adjust downward the content's price, the historical recognition the content has earned over time will sustain a real-time base price higher than the base price as it was initially calculated. In one embodiment, the base price is adjusted based on the historical market data.

The real-time price is designed to be a market-driven, momentum-sensitive price that reflects the value of the underlying content based on the relevant current market data. The real-time price is the price quoted and used in evaluating and trading the underlying content in the content platform. Once the initial marketability requirement is fulfilled and the base price is set, the content pricing subsystem 340 generates a real-time price for the underlying content based on relevant user activities. In one implementation, current market data is measured by comparing relevant user activities incurred during the most recent time session with those incurred during the time session immediately before.

The open price and the close price are intermediate prices designed to assist in generating a real-time price in case of unforeseen events. The content pricing subsystem 340 repeatedly evaluates price changes in time sessions (e.g., every minute, hour, day, week, or any other time duration). In one embodiment, at the beginning of each time session, the content pricing subsystem 340 determines a temporary open price by inheriting the last price (“close price”) of the previous time session. The content pricing subsystem 340 then queries relevant activities to compare the market data change (direction and extent) between the two most recent time sessions, and determines how the price should be adjusted from the inherited last price according to the market data change in the two most recent time sessions. In most cases, the open price of a new session is de facto the most recent session's close price. When an unforeseen event interrupts users' activities (e.g., blackouts), the market data is no longer continuous. As a result, the content pricing subsystem 340 adjusts the open price to reflect the abruption. For example, the content pricing subsystem 340 can reset the open price to be the base price. As another example, in response to abruptions such as a no-visit-at-all crisis, the open price can be adjusted according to a predetermined ratio (e.g., half of the close price or most recent real-time price). Subsequent real-time prices will be adjusted based on the open price. At the end of the current time session, the last real-time price will be locked as the close price (also referred to as last price) for the current session and will be inherited as the next open price.

The pricing algorithms generate pricing information based on market data derived by business rules from content information (e.g., topic and category) and tracked user activities. FIG. 4B is a flow diagram illustrating an example operation 420 of the content pricing subsystem 340 to apply the pricing algorithms to generate pricing information in accordance with one embodiment of the invention. In one embodiment, in order for the content pricing subsystem 340 to execute the operation 420 to generate pricing information for a piece (or series) of content, the publisher must turn on the automated pricing service for the content.

As illustrated, the content pricing subsystem 340 applies business rules to identify related reader market(s) and to weigh 421 relevant content topics (and/or categories, subcategories) of underlying content based on their corresponding content category constants. The content pricing subsystem 340 also applies business rules to weigh 423 activity factors for tracked relevant user activities based on their corresponding activity factor constants. If the publisher just turned on the automated pricing service, the content pricing subsystem 340 retrieves 425 relevant user activity data (e.g., from the user activity tracking database), and applies 427 the all-activity-factor algorithm to determine whether the underlying content is eligible for a base price (e.g., based on the MinAct thresholds), and if so, generates a base price. If the automated pricing service was turned on a while back (that is, the all-activity-factor algorithm has already been applied) and the content pricing subsystem 340 just tracked a relevant user activity, the content pricing subsystem 340 applies 429 the single-activity-factor algorithm to generate pricing information for the underlying content.

The all-activity-factor algorithm is triggered by publishers turning on the automated pricing service (e.g., turning on the PriceSensor service). If a publisher turns on the automated pricing service (either for the first time or comeback), the content pricing subsystem 340 retrieves content information (e.g., topic, category), queries relevant user activities, and applies the all-activity-factor algorithm for base price. The all-activity-factor algorithm determines whether the underlying content is marketable enough to set up base price (e.g., comparing relevant user activities with MinAct thresholds). If not, then the content remains freely available, and if yes then the all-activity-factor algorithm determines a base price. In order to make the determination, the all-activity-factor algorithm takes into account factors such as the content category, relevant user activities, and corresponding thresholds such as MinAct thresholds, in accordance with one embodiment. For example, for a love story, the all-activity-factor algorithm compares all tracked relevant user activities to their corresponding MinAct thresholds (e.g., MinAct threshold for bookmark activity for love stories). If any of the corresponding MinAct thresholds is passed, the algorithm determines the base price. In an alternate embodiment, the content pricing subsystem 340 checks for base price for all activity factors (in parallel or sequentially), and then calculates a comprehensive base price based on the individual base prices for each activity factor and their corresponding activity factor constants. For example, the content pricing subsystem 340 can multiply each individual base price by its corresponding activity factor constant, and then add the results together to generate the comprehensive base price. The content pricing subsystem 340 sets the base price in the financial charge database (or pricing database). In case tracked relevant user activities are well surpassing the MinAct threshold at setup (e.g., the publisher turns on the automated pricing service for a piece of content after publishing it free of charge for a long time), the underlying content deserves a price higher than the base price. In this case, the all-activity-factor algorithm sets a base price that is higher (or lower) than the base price that it would otherwise set.

Once the automated pricing service is turned on, the single-activity-factor algorithm is triggered and used by tracked relevant user activities. The user activity can be any of the activity factors (e.g., page view, purchase, bookmarking the underlying content). If a base price has not been generated, the content pricing subsystem 340 applies the single-activity-factor algorithm to determine whether the underlying content is marketable enough to set up a base price. If not, then the content remains freely available, and if yes then the single-activity-factor algorithm determines a base price. If the base price has already been set, or the single-activity-factor algorithm determines that the underlying content deserves a price different from the base price, the single-activity-factor algorithm calculates a real time price for the content.

In one embodiment, the pricing algorithm (all-activity-factor algorithm or single-activity-factor algorithm) determines whether a piece of content is marketable enough to set up a base price by measuring its tracked relevant user activities against applicable MinAct thresholds. For example, if the piece of content has 570 bookmarks and the MinAct threshold for bookmark activity factor is 400, then the pricing algorithm determines that it is sufficiently marketable and assigns a base price. The MinAct threshold may vary among different topics/categories. For example, love stories are generally popular and may have high MinAct thresholds (e.g., 1000 for bookmark activity factor), and philosophic papers are generally unpopular and may have low MinAct thresholds (e.g., 100 for bookmark activity factor). Rather than measuring activity volumes, the pricing algorithm may measure the corresponding price weighing values instead. Similar to the MinAct thresholds, the base price also may vary among different topics/categories. For example, the base price for love stories may be $0.05 while the base price for investment advises may be $0.50.

In one embodiment, the pricing algorithm determines real time prices by comparing accumulated price weighing values of relevant user activities tracked during the two most recent time sessions. For example, assume a time session is an hour and the current time is 11:53 AM. The content pricing subsystem 340 calculates a cumulative price weighing value (for one user activity factor or all user activity factors) for relevant user activities tracked between 09:54 AM and 10:53 AM (the hour before) and those tracked between 10:54 AM and 11:53 AM (the previous hour). The content pricing subsystem 340 compares the two values for market movements. If the price weighing value for the previous hour is higher, the content pricing subsystem 340 can conclude that the underlying content is gaining popularity and therefore can increase its price, and otherwise keeps the real time price unchanged or lower it. It is noted that the content pricing subsystem 340 can make the calculation at any time (e.g., when a user activity is tracked), and not necessarily at the beginning or end of a time session.

Continue with the above example of the adventure story and the philosophic paper, assume the adventure story has a total 1000-page view during the hour before, and a total 500-page view during the previous hour. The content pricing subsystem 340 reads the market downward for this adventure story in a trend-weighing value of (500−1000)×0.5×0.2=−50, where 0.5 is the content topic constant for adventure stories and 0.2 is the activity factor constant for page view. The philosophic paper has a total 1000-page view during the hour before and a total 500-page view of the previous hour. The content pricing subsystem 340 concludes a trend-weighing value of (500−1000)×0.9×0.2=−90, where 0.9 is the content topic constant for philosophic papers. The content pricing subsystem 340 senses more severity in the decreasing readership in the philosophic paper, which in turn will lower price more noticeably.

As demonstrated, the design and introduction of online market (readership) relevancy constants (i.e. the content topic constants and the activity factor constants) in the market-based, reality-sensible pricing algorithms are used to quantify market data to determine marketability and price information.

In one embodiment, the pricing algorithms and the business rules include fixed logic design and formula structure and dynamic variables. For example, a pricing algorithm may apply different business rules (e.g., in determining marketability for setting up base price) or apply different price change scale controls (e.g., how big or small a price difference should be made between price updates). As another example, a business rule may apply different activity factors, content topic/category, and/or weight values (e.g., activity factor constants, content topic constants). The dynamic variables can be determined or adjusted in real time as the content pricing subsystem 340 deems necessary. For example, if the content pricing subsystem 340 determines that love stories in general are gaining popularity (e.g., by detecting an increase in user activities related to most content in the love story category), it can adjust the value of the content topic constant accordingly.

In one embodiment, user activities and content information are tracked (by the activity tracking subsystem 330) in the background constantly, disregarding whether the subject content is set for automated pricing service. These tracked data create a comprehensive and relatively accurate picture about the marketability (or popularity, potential sellability) of the content in its reader market. If the automated pricing service is turned on, then the relevant user activities can be used to determine the initial base price, and to update the price in real-time in the form of two price curves: one for the base price, which acknowledges historical activity credit, gradually increases over time, and serves as a lowest sustaining price the content can go down to upon a market crash; the other for the real time price, which focuses on the visitor activity trend comparison between time sessions, and adjusts the real-time price to respond to market movements as defined by the market data collecting/storing mechanism.

A publisher may at any time decide to turn on or off the automated pricing service. As described above with reference to FIG. 4B, responding to the publisher turning on the service, the content pricing subsystem 340 generates pricing information by applying pricing algorithms. If the publisher turns off the service, then the content pricing subsystem 340 removes the generated price from the financial charge database. As noted above, regardless of a user's decision, the market data around the content is always real-time updated and available for use.

### Example Operation for Content Pricing System

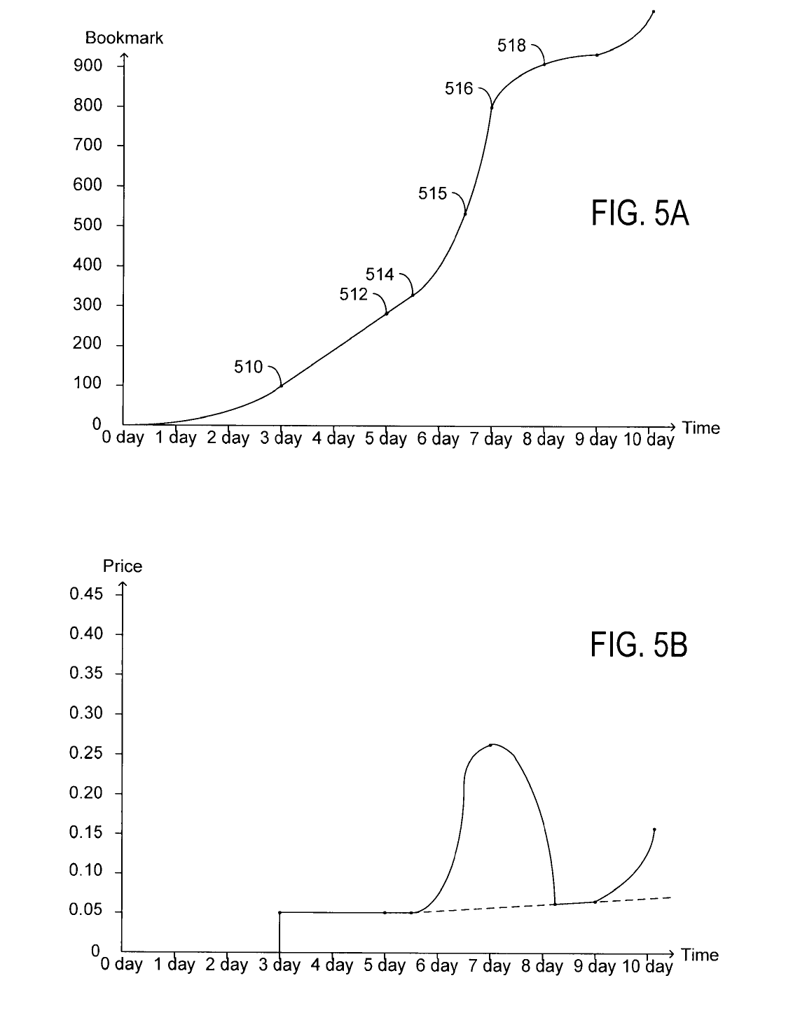

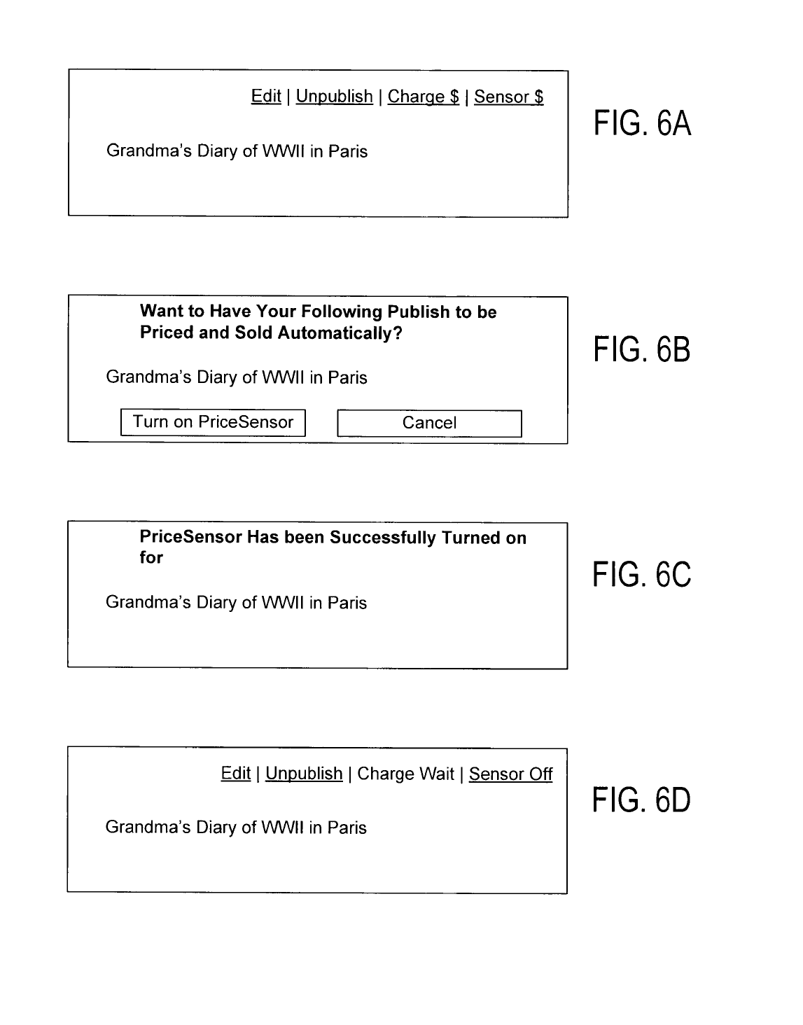

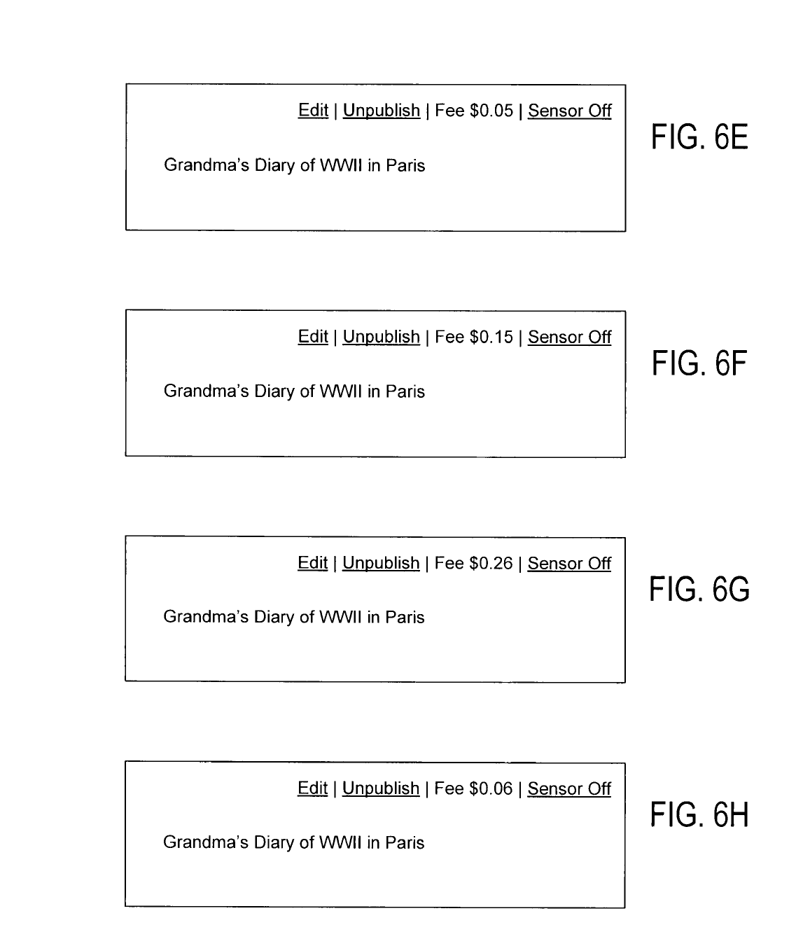

The operations of the content pricing subsystem 340 can be further illustrated through the following example and the accompanying FIGS. 5A-5B and 6A-6H in accordance with one embodiment of the invention. FIG. 5A is a time-sequence diagram for user activity bookmarks tracked for a piece of content. FIG. 5B is a time-sequence diagram for corresponding price movements (real time price and base price) for the content during the same time period. FIGS. 6A-6H include a series of screenshots illustrating corresponding user experience for the publisher of the piece of content on the content platform provided by the content commerce system 110.

The publisher publishes a series of articles on the content platform and titles them Grandma's Diary of WWII in Paris (the underlying content). After the content is published, the publisher can choose a pricing model for it. FIG. 6A is a screenshot showing a content management page the content commerce system 110 rendered to the publisher for him to select a pricing model in accordance with one embodiment. The web page lists the title of the content and presents several controls: Edit, Unpublish, Charge $, and Sensor $. The publisher can select the control Edit to modify the content, select the control Unpublish to remove the content from public access, select the control Charge $ to set a fixed DIY price for the content or to avail it for free, or select the control Sensor $ to request the content commerce system 110 to automatically generate pricing information for the content.

Assuming the user selected the control Sensor $ for automatically generated pricing information, the content commerce system 110 prompts the user for confirmation. FIG. 6B illustrates an example web page requesting user confirmation in accordance with one embodiment. The user can either confirm by selecting the Turn on PriceSensor button or decline by selecting the Cancel button. If the user selects the Turn on PriceSensor button, the content commerce system 110 generates a web page illustrated in FIG. 6C confirming that the PriceSensor is turned on, and the user can return to the content management screen (or web page). As illustrated in FIG. 6D, the controls listed in the content management screen are changed to include an indicator Charge Wait and a control Sensor Off, instead of Charge $ and Sensor $. In the meantime, the activity tracking subsystem 330 tracks all kinds of visitor activities on all published content and singles out the data about the specific content piece on which a publisher turns on PriceSensor.

When the publisher turns on the automated pricing service, the content pricing subsystem 340 applies the all-activity-factor algorithm to determine whether the underlying content is marketable enough for a base price, and if so, to set the base price. In the current example, only bookmark activity factor is considered for clarity, and the MinAct threshold for bookmark activity factor is 100. As illustrated in FIG. 5A, when the content is first published, there is no relevant bookmark user activity. The pricing algorithm determines that the content is not popular enough to warrant a base price. As a result, the content is published for free, as illustrated in FIG. 5B.

After the content is published, it starts to attract users and interested visitors start bookmarking it, as illustrated in FIG. 5A. Each time a visitor bookmarks the content, the activity tracking subsystem 330 tracks the bookmark user activity, and the content pricing subsystem 340 applies the single-activity-factor algorithm to determine whether the content is marketable enough to be placed with a price tag (the base price). In other words, the content pricing subsystem 340 determines whether the content is popular enough to be actually sellable on the market based on both the real-time and historical user activities the activity tracking subsystem 330 tracked as well as the applicable business rules. If the content pricing subsystem 340 determines that the content is not marketable enough, it leaves the content free as is and continues to track related user activities.

Once an applicable business rule indicates that the content is sufficiently marketable (e.g., enough bookmark user activities), the content pricing subsystem 340 generates a base price for the content appropriate to the content's specific nature (media format, category, etc.), and generates a real-time price based on the base price.

The content attracts its 100^{th} bookmark on the third day after it is published, as shown in FIG. 5A. Response to the content's relevant bookmark activities passing the MinAct threshold, the content pricing subsystem 340 sets a base price of $0.05, as shown in FIG. 5B. The real time price for the content is also $0.05. It is noted that in FIG. 5B, the real time price is shown as solid line and the base price is shown as dotted line. When the two price overlaps, the overlap portion is shown as solid line. In one embodiment, the content pricing subsystem 340 keeps the base price and the real time price stable for two consecutive time sessions (referred to as grace period) after the base price is first set. The purpose of the grace period is to collect enough market data under the base price to determine market movements and adjust the real time price after the grace period. During the grace period, the content commerce system 110 generates a web page for the publisher, showing that the price is $0.05 in place of the indicator Charge Wait, as illustrated in FIG. 6E.

The activity tracking subsystem 330 tracks user activities in real time and the content pricing subsystem 340 adjusts content prices in real time based on the tracked user activities. If relevant user activities indicates that the content gains popularity (e.g., more page views and/or bookmarks), the content pricing subsystem 340 determines to increase the content price, and vice versa.

As illustrated in FIG. 5A, in one embodiment the grace period ends by the fifth day. Within half a day after the grace period ends (referred to as the first period), the content steadily receives new bookmarks at a same (or substantially similar) rate as it receives during the grace period. The curve portion between 510 and 512 illustrates relevant bookmarks tracked during the grace period, and the portion between 512 and 514 illustrates the relevant bookmarks tracked during the first period. As illustrated in FIG. 5A, the content attracts user bookmarks at a rate of about 100 bookmarks per day during the grace period and the first period. The content pricing subsystem 340 applies the single-activity-factor algorithm during the first period when a new bookmark is tracked. The pricing algorithm compares the trend-weighing value for the time session (in this example, a 24-hour period) immediately before the current time (referred to as the previous time session) with the trend-weighing value for the time session before. Assuming the applicable content topic constant is 0.5 and the applicable activity factor constant is 0.9, the difference between the two trend-weighing values is 0.5×(100×0.9)−0.5×(100×0.9)=0. Therefore, during the first period, the content pricing subsystem 340 does not detect market trend changes, and therefore keeps the real time price unchanged ($0.05).

During the next one and a half days, the content quickly gains popularity and its bookmark rate increases rapidly, as illustrated in FIG. 5A by a curve portion between 514 and 516. The content pricing subsystem 340 detects this market trend change in real time and adjusts the real time price on the fly. For example, during the middle of the 6^{th} day, the content pricing subsystem 340 compares the trend-weighing value for the previous 24-hour period (illustrated by the curve between 514 and 515) and the trend-weighing value for the period before. The difference is 0.5×(200×0.9)−0.5×(100×0.9)=45, and suggests that the content is gaining popularity at a high rate. In return, the content pricing subsystem 340 adjusts the real time price at a rate proportional to the market trend change, to fully enjoy and monetize the rising momentum in real-time. As illustrated in FIG. 5B, the real time price is increased from $0.05 at day 5 to $0.26 at day 7. FIGS. 6F and 6G show web pages generated for the publisher during this period reflecting the price increase in accordance with one embodiment.

During the next two days, the reader market adjusts and the bookmark rate reduces. This market adjustment can be a result of readers' hesitation or reaction to the increased content price (thus taking no action) and other factors such as disappointing or otherwise negative ratings buyers left after their purchase/reading, or a declining interest in WWII related articles in general after the article received some momentum and made some sell earlier. The content pricing subsystem 340 detects this downturn market movement in real time and reduces the real time prices on the fly. For example, on the 8^{th} day, the difference between the trend-weighing values for the previous session (illustrated by curve portion between 516 and 518) and the session before is 0.5×(100×0.9)−0.5(400×0.9)=−135. As a result, the content pricing subsystem 340 drastically lowers the real time price to reflect this reader market adjustment. As illustrated in FIG. 5B, the content pricing subsystem 340 reduces the real time price to be the same as the base price. As discussed above, the base price serves as an on-going bottom price reflecting accumulated value over time. The content pricing subsystem 340 gradually adjusts the base price based on the cumulative relevant user activities. As illustrated, the base price is increased from $0.05 to $0.06. Therefore, the real time price is adjusted to $0.06 and not lower. FIG. 6H shows a web page reflecting the price drop.

The reader market quickly adjusts to the price reduction and the bookmark rate quickly starts increasing again, as illustrated in FIG. 5A. The content pricing subsystem 340 raises the real time price accordingly, as illustrated in FIG. 5B. As time passes, the bookmark rate will reach a stable rate and changes more gradually. So will the real time price.

The publisher can turn off (and on again) the automatic price generation at any time by selecting the control Sensor Off as shown in FIGS. 6D-6H. In addition, the publisher can switch between the automated pricing service, the fixed-rate DIY charging system, and leaving content completely free, at will. In one example, responsive to the user selecting the control Sensor Off, the content commerce system 110 generates a web page prompting for user confirmation similar to FIG. 6B. Upon confirmation, the content commerce system 110 generates a web page confirming that the PriceSensor is turned off. The content management page changes back to its original layout as illustrated in FIG. 6A. If the publisher selects the control Sensor $ again, the content commerce system 110 prompts for confirmation as illustrated in FIG. 6B. Upon receiving the publisher's confirms, the content commerce system 110 resumes automatically determining the prices. In one embodiment, the content pricing subsystem 340 uses the last real time price before the automated pricing service was previously turned off as the starting real time price.

It is noted that the screenshots illustrated in FIGS. 6A-6H are only made available (e.g., by the content pricing subsystem 340) to the publisher under his personal account, and not visible to the general public. Visitors can see the price tag for the content Grandma's Diary of WWII in Paris when they try to access the content.

### Alternative Embodiments

In alternate embodiments, the content pricing subsystem 340 can be configured to generate relatively stabilized real-time prices for content pieces (or series). In one embodiment, rather than measuring time sessions relative to the time when user activities are tracked, the content pricing subsystem 340 can be configured to set time sessions to start and end at particular times. For example, assume a time session is an hour (or a day, a week, etc.). The content pricing subsystem 340 can set the starting time of each time session to be the starting time of each hour according to a standard time (e.g., Greenwich Mean Time). In this embodiment, an open price is calculated at the beginning of each hour based on cumulative price weighing values calculated for the previous time sessions in a manner similar to the methods described above. Subsequently, the content pricing subsystem 340 calculates and adjust real-time price based on the open price and user activities tracked within the current time session until the current time session ends.

For example, the content pricing subsystem 340 can calculate real-time price using the following formula: Real-Time Price=Open Price+Base Price/Adjust Factor. The adjust factor can be a fixed value, or a value determined (or affected) by relevant data such as user activities tracked during previous time session. Assume the open price for a piece of content at 11:00 AM is $1.28, the adjust factor is 15, the first bookmark activity for the current hour is tracked at 11:01 AM, and the base price at that moment is $0.30. The real-time price at that moment would be $1.28+0.30/15=$1.30. Assume at 11:49 AM, when the 188^{th} bookmark is detected, the base price is adjusted to $0.39. As a result, the real-time price at 11:49 AM would be adjusted to $1.28+0.39/15=$1.31 (rounded to the nearest cent).

As a result, the content price is relatively stable within the hour, but still increases at a gradual pace, reflecting the content's popularity. The open price of the next time session (12:00 PM to 1:00 PM for the above example) will be calculated based on the cumulative price weighing values calculated for the previous time sessions in a manner similar to the methods described above.

The above embodiments provides an online content e-commerce platform for end users to publish, access, and trade content online (a consumer-to-consumer platform). One skilled in the art would understand that the disclosed system and method can provide a content platform for business to publish and sell content to end users (a business-to-consumer platform), or among businesses (a business-to-business platform).

In addition to enable Internet users to publish, access, and trade content, the present invention may also provide non-content e-commerce platform for Internet users. For example, users can advertise, demonstrate, and/or trade commodities and services such as car/food, movie/sports ticketing, restaurant/hotel/travel booking, teaching/training, professional/care services, housing/renting, and advertising. The system can track user activities and automatic generate dynamic pricing information based on user activities (or lack of activity) in a manner similar to the methods detailed above, regardless of sellers being individuals or companies and regardless of commodities being content or non-content.

The disclosed embodiments advantageously provide a convenient way for ordinary Internet users to publish content online and receive financial benefit from the published content. A user does not need to understand the relevant reader market or marketability of the subject matter, and only needs to simply turn on the conveniently provided automated pricing service. The service will determine content price that is totally market-driven, dynamic, and real-time. The determined content prices also beneficially reflect all individual activities with their allocated weights per business rules, as embodied in the pricing algorithms.

Some portions of above description describe the embodiments in terms of algorithmic processes or operations, for example, the processes and operations as described with FIGS. 4A and 4B. These algorithmic descriptions and representations are commonly used by those skilled in the data processing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the disclosure. This description should be read to include one or at least one and the singular also includes the plural unless it is obvious that it is meant otherwise.

Upon reading this disclosure, those of skill in the art will appreciate still additional alternative structural and functional designs for a system and a process for enabling Internet users to conveniently publish content online and receive financial benefits from the published content. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus disclosed herein without departing from the spirit and scope as defined in the appended claims.

What is claimed is:

1. A computer-implemented method for dynamically determining a price for a piece of content, the method comprising:
publishing the piece of content for free for a period of time;
categorizing the piece of content to determine a related category;
tracking user activities related to the piece of content during the period of time;
determining a marketability value of the piece of content by applying a business rule to the related category and the tracked related user activities;
responsive to the marketability value exceeding a threshold, determining a price for the piece of content by applying a pricing algorithm to the marketability value; and
setting the price for the piece of content for subsequent accesses.

2. The method of claim 1, further comprising:
continuously tracking subsequent user activities related to the piece of content; and
adjusting the price by applying the pricing algorithm to the subsequent user activities.

3. The method of claim 2, wherein adjusting the price comprises:
quantifying user activities incurred during a previous time session into a first trend-weighing value;
quantifying user activities incurred during a time session immediately before the previous time session into a second trend weighing value;
calculating a difference of the first and second trend weighing values; and
adjusting the price based on the difference.

4. The method of claim 3, wherein quantifying user activities comprises:
quantifying each user activity based on an activity factor constant associated with the user activity and a content topic constant associated with the piece of content.

5. The method of claim 1, wherein the marketability value comprises a volume of the user activity.

6. The method of claim 1, wherein tracking user activities comprising:
tracking multiple levels of user activities, including user activities associated with a user and a piece of content, user activities associated with a piece of content, and user activities that are not associated with any user or content.

7. The method of claim 1, further comprising determining a bottom price for the piece of content based on all user activities related to the piece of content, wherein the price will not be adjusted to be lower than the bottom price.

8. A system for dynamically determining a price for a piece of content, the system comprising:
a user management subsystem configured for managing user information of a user publishing the piece of content and users accessing the piece of content;
a content management subsystem configured for categorizing the piece of content to determine a related category, and for publishing the piece of content;
an activity tracking subsystem configured for continuously tracking user activities related to the piece of content; and
a content pricing subsystem configured for initially availing the piece of content free, subsequently determining a marketability value of the piece content by applying a business rule to the related category and the tracked related user activities, determining a price for the piece of content by applying a pricing algorithm to the marketability value responsive to the marketability value exceeding to a threshold, and setting the price for the piece of content for subsequent accesses.

9. The system of claim 8, wherein the content pricing subsystem is further configured to continuously tracking subsequent user activities related to the piece of content, and adjusting the price by applying the pricing algorithm to the subsequent user activities.

10. The system of claim 9, wherein adjusting the price comprises:
quantifying user activities incurred during a previous time session into a first trend-weighing value;
quantifying user activities incurred during a time session immediately before the previous time session into a second trend weighing value;
calculating a difference of the first and second trend weighing values; and
adjusting the price based on the difference.

11. The system of claim 10, wherein quantifying user activities comprises:
quantifying each user activity based on an activity factor constant associated with the user activity and a content topic constant associated with the piece of content.

12. The system of claim 8, wherein the marketability value comprises a volume of the user activity.

13. The system of claim 8, wherein tracking user activities comprising:
tracking multiple levels of user activities, including user activities associated with a user and a piece of content, user activities associated with a piece of content, and user activities that are not associated with any user or content.

14. The system of claim 8, wherein the content pricing subsystem is further configured for determining a bottom price for the piece of content based on all user activities related to the piece of content, wherein the price will not be adjusted to be lower than the bottom price.

15. A computer program product for dynamically determining a price for a piece of content, the computer program product comprising a computer-readable medium containing computer program code for performing a method comprising:
publishing the piece of content for free for a period of time;
categorizing the piece of content to determine a related category;
tracking user activities related to the piece of content during the period of time;
determining a marketability value of the piece of content by applying a business rule to the related category and the tracked related user activities;
responsive to the marketability value exceeding a threshold, determining a price for the piece of content by applying a pricing algorithm to the marketability value; and
setting the price for the piece of content for subsequent accesses.

16. The computer program product of claim 15, wherein the method further comprises:
continuously tracking subsequent user activities related to the piece of content; and
adjusting the price by applying the pricing algorithm to the subsequent user activities.

17. The computer program product of claim 16, wherein adjusting the price comprises:
quantifying user activities incurred during a previous time session into a first trend-weighing value;
quantifying user activities incurred during a time session immediately before the previous time session into a second trend weighing value;
calculating a difference of the first and second trend weighing values; and
adjusting the price based on the difference.

18. The computer program product of claim 17, wherein quantifying user activities comprises:
quantifying each user activity based on an activity factor constant associated with the user activity and a content topic constant associated with the piece of content.

19. The computer program product of claim 15, wherein the marketability value comprises a volume of the user activity.

20. The computer program product of claim 15, wherein tracking user activities comprising:
tracking multiple levels of user activities, including user activities associated with a user and a piece of content, user activities associated with a piece of content, and user activities that are not associated with any user or content.

21. The computer program product of claim 15, wherein the method further comprises determining a bottom price for the piece of content based on all user activities related to the piece of content, wherein the price will not be adjusted to be lower than the bottom price.
